(19) United States
(12) Patent Application Publication
(10) Pub. No.: US 2011/0176338 A1
(43) Pub. Date: Jul. 21, 2011

(54) Electrical power adaptor with self-adjusting output voltage regulation

(76) Inventor: Ting HUANG, Guangzhou City (CN)

(21) Appl. No.: 12/779,966

(22) Filed: May 14, 2010

(30) Foreign Application Priority Data
Jan. 19, 2010 (CN) 201020027018.8

(51) Int. Cl. H02M 3/335

(52) U.S. Cl. 363/21.12

(57) ABSTRACT

The present invention relates to an electrical power adaptor with self-adjusting output voltage regulation which comprises a switching power supply circuit for converting an alternate current into a direct current, and a power supply return circuit connecting with the switching power supply circuit. The switching power supply circuit comprises an EMI filter circuit, a full-bridge rectifier circuit, a switching transformer, a secondary rectification filter circuit, a PWM control circuit and an optocoupler feedback control circuit. The power supply return circuit comprises an output line, output adaptor and an MCU main control circuit. The MCU main control circuit is connected with the switching power supply circuit. The output adaptor is disposed with a signal resistor. The MCU main control circuit controls the output voltage of the switching power supply circuit according to the signal resistor of the output adaptor. The electrical adaptor of the present invention provides a wider range of output voltages with higher precision. Furthermore, by connecting a signal resistor to an output adaptor and altering feedback resistance of a feedback network according to feedback signals of the signal resistor, the signal resistor is not required to meet a very high standard of precision. The design of the present invention is safer and more personalized.

### BACKGROUND OF THE INVENTION

The present invention relates to an electricity supply device for home appliances and office equipment and more specifically to an electrical power adaptor with self-adjusting output voltage regulation.

With the popularity of personal digital equipment and laptop computers, external power supply has become indispensible. Generally, every personal digital equipment and laptop computer is provided with its own specific electrical power adaptor, but this results in waste of resources. As it is sometimes hard to distinguish between different electrical power adaptors, wrong connection may occur and as a result, home appliances or office equipment may be burnt and destroyed. The existing universal power adaptors are generally operated by adjusting manually the values of electronic components to obtain the required power supply voltage and current. However, such control technology is deficient in that it is inflexible to control and it is unable to ascertain the adjusted value accurately. Further, it may easily burn and destroy the appliances or result in power shortage. It is not safe to use and it lacks personalization. Another kind of existing electrical power adaptor is disposed with a feedback resistor connected to the adaptor. As different adaptors are connected with different feedback resistors, it is possible to provide different output voltages. However, such design requires relatively precise feedback resistors. Its cost of production is high as well because one feedback resistor can only provide one output voltage.

### BRIEF SUMMARY OF THE INVENTION

In view of the disadvantages now present in the prior art, the present invention provides an electrical power adaptor with self-adjusting output voltage regulation which is capable of obtaining a precise output voltage with simple operation, safe to use and more personalized.

The electrical power adaptor with self-adjusting output voltage regulation of the present invention comprises a switching power supply circuit for converting an alternate current into a direct current, and a power supply return circuit connecting with the switching power supply circuit; the power supply return circuit comprises an output line and at least one output adaptor; the power supply return circuit further comprises an MCU main control circuit; the output adaptor is disposed with a signal resistor; the MCU main control circuit is connected with the switching power supply circuit; the MCU main control circuit achieves an intelligent control of the output voltage of the switching power supply circuit according to the signal resistor of the output adaptor.

The electrical power adaptor comprises at least two output adaptors, and the signal resistors of different output adaptors have different resistance.

The MCU main control circuit comprises a detection circuit for identifying the signal resistor of the output adaptor, and an MCU for intelligent control of the output voltage of the switching power supply circuit according to the feedback signals detected by the detection circuit.

The switching power supply circuit comprises an EMI filter circuit for filtering EMI noise in an input alternate current, a full-bridge rectifier circuit for converting an alternate current to a direct current, a switching transformer for transforming voltage of the direct current to a voltage required by an equipment under PWM control, a secondary rectification filter circuit for filtering ripples of the direct current from the switching transformer, a PWM control circuit for controlling the switching transformer to generate output voltages of different levels by altering frequencies of PWM signals, an optocoupler feedback control circuit for controlling operation of the switching transformer by applying feedback voltage generated by feedback resistors of different resistance to interfere with preceding PWM.

The MCU main control circuit further comprises a control port for connecting with the switching power supply circuit, providing operating voltage, voltage sampling and current sampling signals to the MCU and receiving voltage regulation control signals and protection control signals against current overflow and overvoltage from the MCU, a power circuit for providing steady operating voltage to the MCU, a feedback network for controlling different MOS to turn on and off so as to generate different feedback resistance values for PWM feedback terminal, a voltage sampling circuit for feeding the output voltage of the switching power supply circuit back to the MCU, a current sampling circuit for feeding an output current of the switching power supply circuit back to the MCU.

The MCU main control circuit further comprises a display circuit for displaying a voltage value of the output voltage, and the display circuit is connected with the MCU.

The electrical power adaptor with self-adjusting output voltage regulation of the present invention is controlled via an MCU (microcontroller) to provide a wider range of output voltages with higher precision. Furthermore, by connecting a signal resistor to an output adaptor, the MCU can alter feedback resistance of a feedback network according to feedback signals of the signal resistor in order to alter the output voltage of the switching power supply circuit and thereby effectively provide reliable power supply to external equipment. Besides, the signal resistor only serves as a kind of signal and therefore it is not required to meet a very high standard of precision. The design of the present invention is safer and more personalized.

### BRIEF DESCRIPTION OF THE DRAWINGS

FIG. 1 is a block diagram of the electrical adaptor of the present invention.

FIG. 2 is a circuit diagram of the switching power supply circuit of the electrical adaptor of the present invention.

FIG. 3 is a circuit diagram of the MCU main control circuit of the electrical adaptor of the present invention.

FIG. 4 is a circuit diagram of the display circuit of the MCU main control circuit of the electrical adaptor of the present invention.

### DETAILED DESCRIPTION OF THE INVENTION

The present invention will be further described below with reference to the accompanying drawings.

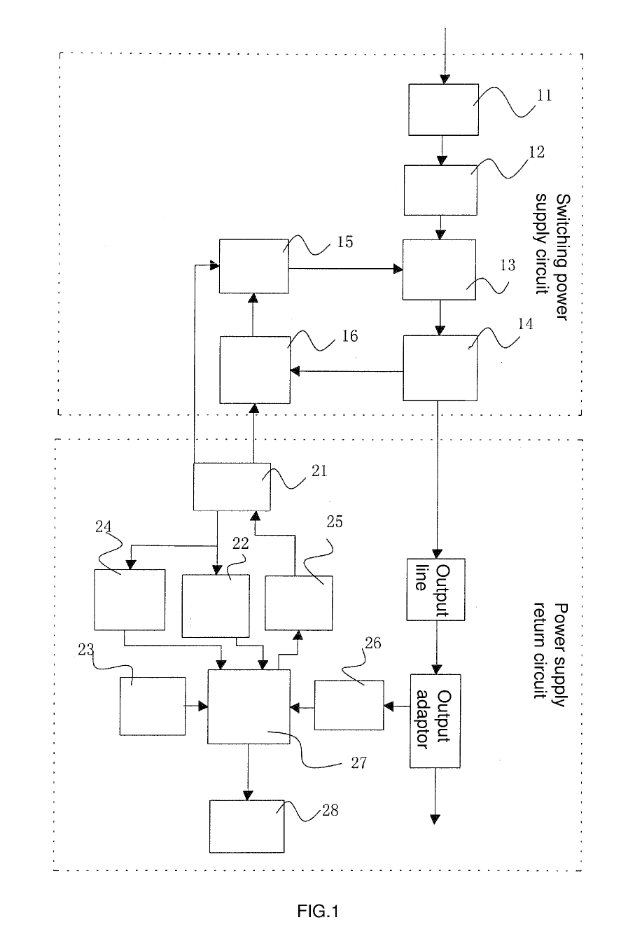

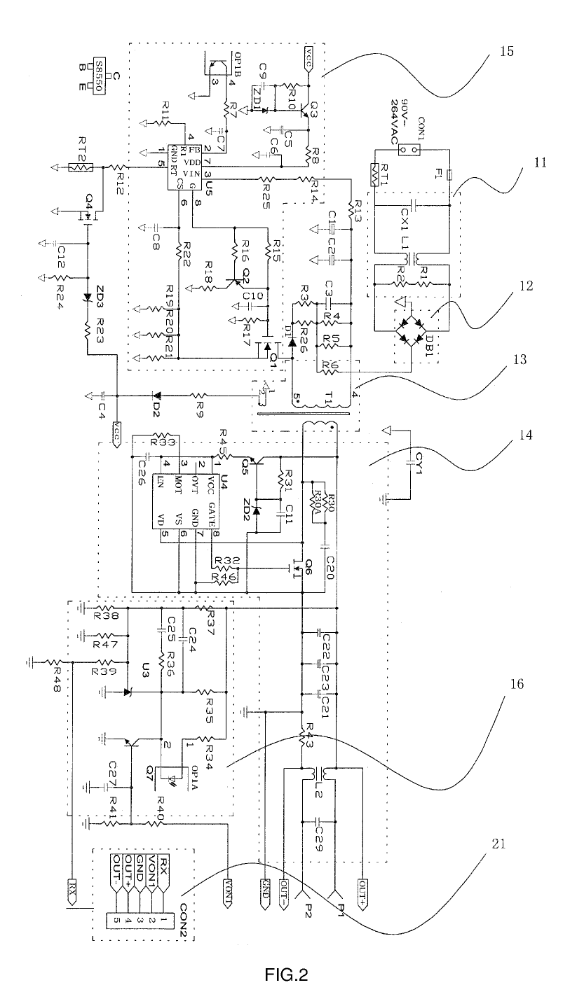

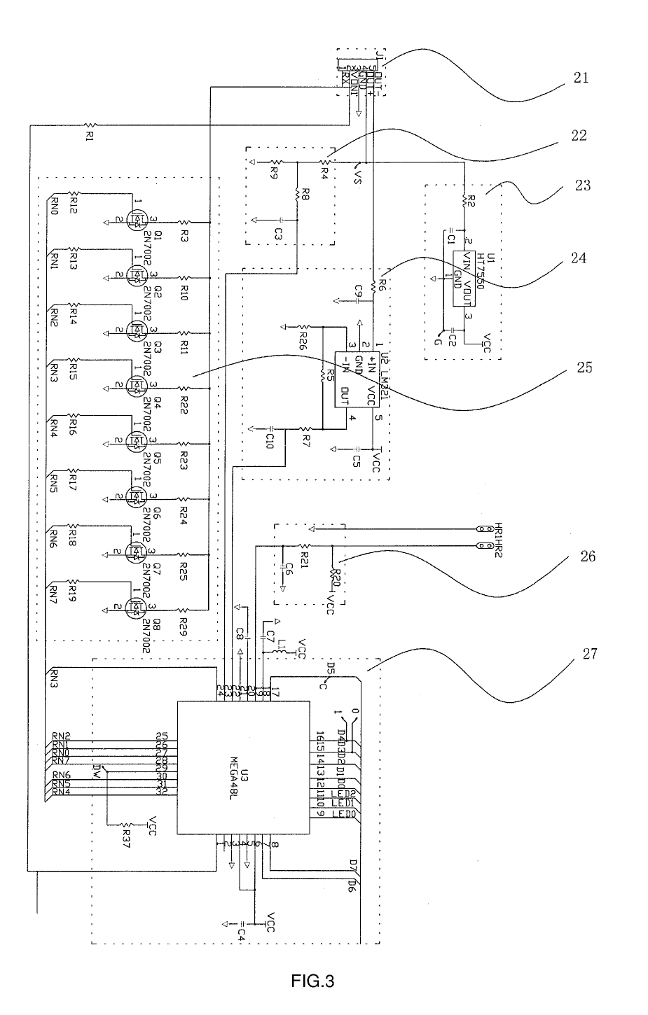

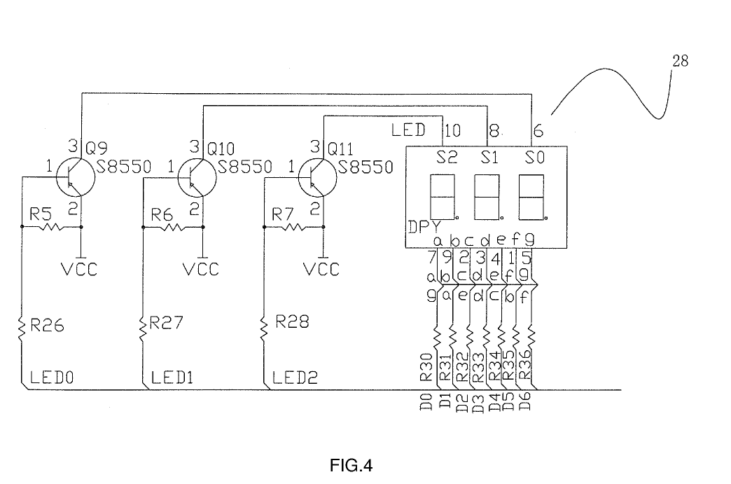

As illustrated in FIG. 1, FIG. 2, FIG. 3 and FIG. 4, the electrical power adaptor with self-adjusting output voltage regulation of the present invention comprises a switching power supply circuit for converting an alternate current into a direct current, and a power supply return circuit connecting with the switching power supply circuit.

The switching power supply circuit comprises an EMI filter circuit 11 for filtering EMI noise in an input alternate current, a full-bridge rectifier circuit 12 for converting an alternate current to a direct current, a switching transformer 13 for transforming voltage of the direct current to a user-specified voltage under PWM control, a secondary rectification filter circuit 14 for filtering ripples of the direct current from the switching transformer 13, a PWM control circuit 15 for controlling the switching transformer to generate output voltages of different levels by altering frequencies of PWN signals, an optocoupler feedback control circuit 16 for controlling operation of the switching transformer by applying feedback voltage generated by feedback resistors of different resistance to interfere with preceding PWM.

The power supply return circuit comprises an output line, at least one output adaptor and an MCU main control circuit. The MCU main control circuit is connected with the switching power supply circuit. The output adaptor is disposed with a signal resistor. The MCU main control circuit achieves an intelligent control of the output voltage of the switching power supply circuit according to the signal resistor of the output adaptor.

The MCU main control circuit comprises a control port 21 for connecting with the switching power supply circuit, providing operating voltage, voltage sampling and current sampling signals to MCU and receiving voltage regulation control signals and protection control signals against current overflow and overvoltage from MCU, a detection circuit 26 for identifying the signal resistor of the output adaptor and transmitting feedback signals to MCU, an MCU 27 for integrating feedback signals, voltage sampling and current sampling signals and transmitting feedback resistance regulation signals, a power circuit 23 for providing steady operating voltage to MCU, a feedback network 25 for controlling different MOS to turn on and off so as to generate different feedback resistance values for PWM feedback terminal, a voltage sampling circuit 22 for feeding the output voltage of the switching power supply circuit back to the MCU, a current sampling circuit 24 for feeding an output current of the switching power supply circuit back to the MCU, and a display circuit 28 for displaying a voltage value of the output voltage.

Every time when a voltage value is adjusted, a signal resistance signal is obtained via the MCU 27, thereby automatically altering the feedback resistance of the feedback network 25 to regulate the output voltage. However, it should be noted that the signal resistor is only serves as an identifying signal. By predefining the relationship between the signal resistor and corresponding output voltage (feedback resistance) through the MCU 27, it is possible to achieve real output voltage control by the MCU with a higher precision.

The common mode choke L1 of the EMI filter circuit 11 of the switching power supply circuit forms a low pass filter with a capacitor CX1 for restraining external interfering signals of high frequency from entering into internal circuit. The full-bridge rectifier circuit 12 converts the AC alternating current input into a direct current by DB1. The switching transformer 13 isolates high voltage and low voltage by T1 with a view to confirm to safety requirements. U5 of the PWM control circuit 15 alters PWM's duty cycle via voltage sampling signals from PIN6 and voltage control signals from PIN2 to achieve output voltage control; U3 of the optocoupler feedback control circuit 16 carries out sampling of output voltage and then provides a voltage control signal to U5 via OP1. The secondary rectification filter circuit 14 restrains signals of high frequency from interfering with external equipment via another common mode choke L2. U4 turns on Q6 by sampling Vds voltage from Q6 when Q1 is turned off to achieve simultaneous rectification.

The output line of the power supply return circuit is a labeled DC output line. The output adaptor is a DC adaptor and is built in with a signal resistor Rf. Different output adaptors correspond to different signal resistors Rf of different resistance.

The MCU main control circuit comprises the control port 21 which is a connection port between the switching power supply circuit and the MCU main control circuit and in which RX is a feedback control line for regulating output voltage PWM, VON1 is an MCU protection signal output line, OUT− is a current sampling line, and OUT+ is a voltage sampling line; the power circuit 23 transforms voltage of a direct current input from OUT+ into steady VCC to provide power to the smart chip MCU; R4 and R9 form output voltage sampling feedback; C1 and C2 filter ripples; the display circuit 28 is a 3-digit display circuit comprising R30, R31, R32, R33, R34, R35, R36, R37, R26, R27, R28, a 3-digit common cathode tube, U3, Q9, Q10 and Q11, wherein PIN9, PIN10 and PIN11 drive the anodes S0, S1 and S2 respectively; R30, R31, R32, R33, R34, R35, R36 and R37 are current limiting resistors of the 3-digit common cathode tube; the current sampling circuit 24 comprises operational amplifier U2 (LM321), amplifying feedback resistor R5 and peripheral R6, R7, R26, C9, C5, C10 and A/D port AD7 (PIN22) of MCU; R6 and C9 constitute an intermediate frequency filters; R5 amplifies feedback; R26 is a bias resistor with positive terminal connected to ground; ADC7 achieves sampling of current signals after amplification; the voltage sampling circuit 22 comprises R4, R9, R8, C3 and A/D port PC0 (PIN23) of MCU, wherein R4 and R9 are connected in series to divide down the voltage to a safe level acceptably by the MCU I/O; C3 is a filter capacitor, PCOachieves voltage sampling; the detection circuit 26 is a divider circuit comprising VCC, Rf and R20 which samples voltage values at two ends of Rf through RC filter comprising R21 and C6 and transmit the same to pin 19 of U3; circuit of the feedback network 25 comprises 8 field-effect transistors and 16 resistors and it is equivalent to a variable feedback resistor; different combinations correspondingly output different feedback resistance for regulating the output voltage; for example, feedback resistance of a 19.5V output voltage is 1.2KΩ and in this case, U3 has to turn off Q1, Q2, Q4, Q6, Q7 and Q8 while turn on Q3 and Q5, resulting in a circuit with only R11 and R23 connected in series to form a feedback circuit, in which R11 is 1.5KΩ and R23 is 8.2 KΩ and the resistance of the two resistors connected in series is 1.2KΩ; the display circuit 28 comprises LED drive circuit with output voltage signals LED0, LED1, LED2 and VCC as reference voltages and Q9, Q10 and Q11 as switching transistors for controlling the lighting of S2, S1 and S0 respectively; for example, when LENO is high, the base of Q9 is also high, and the emitter is also high VCC, so the transistor Q9 is turned off and S0 is not lighted; if the output LENO is low, the base of Q9 is low and the emitter is high, Q9 is opened and S0 is lighted; MCU 27 comprises a core MCU MEGA48L and peripheral reset circuit R37.

What is claimed is:

1. An electrical power adaptor with self-adjusting output voltage regulation which comprises a switching power supply circuit for converting an alternate current into a direct current, and a power supply return circuit connecting with the switching power supply circuit; the power supply return circuit comprises an output line and at least one output adaptor; characterized in that the power supply return circuit further comprises an MCU main control circuit; the output adaptor is disposed with a signal resistor; the MCU main control circuit is connected with the switching power supply circuit; the MCU main control circuit achieves an intelligent control of the output voltage of the switching power supply circuit according to the signal resistor of the output adaptor.

2. The electrical power adaptor with self-adjusting output voltage regulation as in claim 1, characterized in that it comprises at least two output adaptors, and the signal resistors of different output adaptors have different resistance.

3. The electrical power adaptor with self-adjusting output voltage regulation as in claim 2, characterized in that the MCU main control circuit comprises a detection circuit for identifying the signal resistor of the output adaptor, and an MCU for intelligent control of the output voltage of the switching power supply circuit according to the feedback signals detected by the detection circuit.

4. The electrical power adaptor with self-adjusting output voltage regulation as in claim 3, characterized in that the switching power supply circuit comprises:
an EMI filter circuit for filtering EMI noise in an input alternate current;
a full-bridge rectifier circuit for converting an alternate current to a direct current;
a switching transformer for transforming voltage of the direct current to a voltage required by an equipment under PWM control;
a secondary rectification filter circuit for filtering ripples of the direct current from the switching transformer;
a PWM control circuit for controlling the switching transformer to generate output voltages of different levels by altering frequencies of PWN signals;
an optocoupler feedback control circuit for controlling operation of the switching transformer by applying feedback voltage generated by feedback resistors of different resistance to interfere with preceding PWM.

5. The electrical power adaptor with self-adjusting output voltage regulation as in claim 4, characterized in that the MCU main control circuit further comprises:
a control port for connecting with the switching power supply circuit, providing operating voltage, voltage sampling and current sampling signals to the MCU and receiving voltage regulation control signals and protection control signals against current overflow and overvoltage from the MCU;
a power circuit for providing steady operating voltage to the MCU;
a feedback network for controlling different MOS to turn on and off so as to generate different feedback resistance values for PWM feedback terminal;
a voltage sampling circuit for feeding the output voltage of the switching power supply circuit back to the MCU;
a current sampling circuit for feeding an output current of the switching power supply circuit back to the MCU.

6. The electrical power adaptor with self-adjusting output voltage regulation as in claim 5, characterized in that the MCU main control circuit further comprises a display circuit for displaying a voltage value of the output voltage, and the display circuit is connected with the MCU.
